(19) United States
(12) Patent Application Publication
(10) Pub. No.: US 2015/0192254 A1
(43) Pub. Date: Jul. 9, 2015

(54) LED LAMP WITH FULL LIGHT-EMITTING ANGLE AND MANUFACTURING PROCESS THEREOF

(71) Applicants: Daisung MOON, Seoul (KR); Sangpil MOON, Seoul (KR)

(72) Inventors: Daisung MOON, Seoul (KR); Sangpil MOON, Seoul (KR)

(21) Appl. No.: 14/162,785

(22) Filed: Jan. 24, 2014

Related U.S. Application Data
(63) Continuation-in-part of application No. PCT/CN2014/070348, filed on Jan. 9, 2014.

(51) Int. Cl. F21K 99/00; F21V 19/00

(52) U.S. Cl. CPC F21K 9/1355; F21V 19/003; F21K 9/90

(57) ABSTRACT

The present invention relates to a LED lamp with full light-emitting angle and a manufacturing process thereof. The LED lamp comprises a lamp cap, a base, a lamp body and a lamp cover that are successively connected. The lamp body is composed of a drum-shaped base body at the bottom thereof, with longitudinal section of the drum-shaped base body being drum-shaped, a cylinder step at the middle thereof, a polyhedron at the top thereof, a circular groove molded at a junction of the drum-shaped base body and the cylinder step, a round tube having a consistent diameter throughout its length and molded in both the drum-shaped base body and the cylinder step, and a wire groove opened in the polyhedron and communicating with the round tube.

### CROSS-REFERENCE TO RELATED APPLICATIONS

This present application is a Continuation-in-part application of PCT application No. PCT/CN2014/070348 filed on Jan. 9, 2014, the contents of which are hereby incorporated by reference.

### FIELD OF THE INVENTION

The present invention relates to a LED lamp with full light-emitting angle and manufacturing process thereof.

### BACKGROUND OF THE INVENTION

Lamps are classified according to light-emitting angle of LEDs arranged on a LED board, and the LED board of a commonly-used lamp is usually horizontally placed, in this way, the light-emitting angle is between 120 degrees and 180 degrees. If a light-emitting angle above 275 degrees is desired, an optical lens or reflector panel has to be applied to the LED board, alternatively, the LED board has to be vertically placed to make the light reflected downward, however, the space above the lamp may thus be dark. Therefore, additional LED boards are needed to be installed on the vertically placed LED board so as to solve the problems of lighting difficulty above the lamp.

### SUMMARY OF THE INVENTION

The present invention aims to provide a LED lamp with full light-emitting angle, in which an obliquely-placed LED board is provided above a vertically-placed LED board, such that not only the space below the LED lamp but also the space above the LED lamp will be lightened up. The present invention also aims to provide a process of manufacturing a LED lamp with full light-emitting angle.

The technical solution of the present invention is a LED lamp with full light-emitting angle, comprising a lamp cap, a base, a stopper, a lamp body, and a lamp cover that are successively connected, characterized in that: the lamp body is composed of a drum-shaped base body at the bottom thereof, with longitudinal section of the drum-shaped base body being drum-shaped, a cylinder step at the middle thereof, a circular groove molded at a junction of the drum-shaped base body and the cylinder step, a fastening groove in the circular groove, a polyhedron at the top thereof, a transitional circular platform molded between the polyhedron and the cylinder step, a screw hole opened in the transitional circular platform, a circular recess between the transitional circular platform and the cylinder step, a round tube having a consistent diameter throughout its length and molded in both the drum-shaped base body and the cylinder step, and a wire groove opened in the polyhedron and communicating with the round tube; an external surface of the polyhedron is covered over with a LED board matching with a shape of the polyhedron; the LED board is sleeved with a support and is fixed on the lamp body by fastening a hook arranged at the bottom of the support into the circular recess of the lamp body, a stopper is inserted into the wire groove of the polyhedron from the bottom of the round tube of the lamp body and is supported by the base, an end of the lamp cover is fastened to the fastening groove in the circular groove of the lamp body; two wires at the bottom of a LED driver PCB are respectively inserted into a bottom groove of the base and soldered to the lamp cap, while two wires at the top of the LED driver PCB both are inserted into a wire groove in an inner cavity of the stopper and are then fixed to solder joints arranged at the LED board after being drew out of the top of the lamp body.

Preferably, the polyhedron is composed of a right prism at lower part thereof, which is perpendicular to the transitional circular platform, a pyramidal frustum at upper part thereof, which tilts inwards, and a top facet of the pyramidal frustum.

Preferably, the LED board is composed of a polygon facet, a perforation through the center of the polygon facet, a solder joint arranged around the perforation for soldering a wire, a plurality of board bodies extending outwards from each side of the polygon facet, a LED illuminant arranged on each board body, and a polyhedron body formed by connecting adjacent edges of the board bodies and made up of a plurality of vertical boards at lower part of the polyhedron body that are perpendicular to the cylinder step and a plurality of oblique boards at upper part of the polyhedron body that are tilted relative to the cylinder step.

Preferably, the support is composed of a ring covering the transitional circular platform of the lamp body, a plurality of hooks protruding downwards from the bottom of the ring to be fastened to the circular recess of the lamp body, a frame protruding upwards from the top of the ring and arranged at lower part of the support, which matches with the vertical board of the LED board, a frame at upper part of the support, which matches with the oblique board of the LED board, a frame at the top of the support, which matches with the polygon facet of the LED board, and a plurality of through-holes in the ring.

Preferably, the stopper is composed of a circular plate, an annular bearing body protruding downwards from the bottom of the circular plate and inserted in an opening end of the base, a plurality of screw holes opened in the circular plate, a semicircular notch opened in the annular bearing body, which matches with the screw hole of the circular plate, a step-like cylinder protruding upwards from the top of the circular plate, diameter of the step-like cylinder decreasing with increasing height of the cylinder, and a wire groove opened in an interior of the step-like cylinder, diameter of the wire groove decreasing with increasing height of the wire groove.

Preferably, a space between the base and the LED driver PCB is filled with a heat radiation rubber to make heat of the LED driver PCB dissipated out.

Preferably, the LED board is composed of a circle of board bodies forming a lower prism and an upper pyramidal frustum, each board body consisting of a vertical board at lower part thereof and an oblique board at upper part thereof, two adjacent vertical boards forming a vertical edge, and each oblique board tilting inwards along a horizontal edge, two solder joints respectively arranged at two adjacent oblique boards, LED illuminants arranged on the vertical board and on the oblique board.

Another technical solution of the present invention is a process of manufacturing a LED lamp with full light-emitting angle, characterized by comprising the following steps of:

(1) mounting a LED driver PCB into a base, and inserting one wire at the bottom of the LED driver PCB into a bottom groove of the base;
(2) connecting a lamp cap to the base by a threaded connection, then soldering another wire at the bottom of the LED driver PCB to the lamp cap, and filling a space between the base and the LED driver PCB with a heat radiation rubber to make heat of the LED driver PCB dissipated out;
(3) mounting a stopper into both the base and a lamp body, then inserting two wires at the top of the LED driver PCB into a wire groove in an inner cavity of the stopper, and drawing the wires out of the top of the lamp body;
(4) screwing a screw into a screw hole of a transitional circular platform of the lamp body, a screw hole of the stopper, and a screw hole of the base to make the lamp body and the stopper connected with the base;
(5) covering each facet of a polyhedron of the lamp body with a LED board to make heat of a LED illuminant dissipated out, and fixing the two wires at the top of the LED driver PCB to solder joints arranged at the LED board;
(6) sleeving the LED board with a support, and then fastening a hook arranged at the bottom of the support into a circular recess between the transitional circular platform and a cylinder step of the lamp body;
(7) fastening a fastener arranged at an end of a lamp cover into a fastening groove arranged in a circular groove of the lamp body to complete assembling of the LED lamp.

Compared with prior art, the present invention has advantages as following.

(1) By tilting LED board of the present invention, users may adjust angle of emitted light according to the need.

(2) By tilting LED board of the present invention, not only the space above the LED lamp will be lightened up, but also the space below the LED lamp will be brighter to reach a standard brightness for a LED lamp.

### BRIEF DESCRIPTION OF THE DRAWINGS

FIG. 1 is an exploded view of a LED lamp with full light-emitting angle of the present invention.

FIG. 2 is a sectional view of an assembled LED lamp with full light-emitting angle of the present invention.

FIG. 3 is a perspective view of a LED board of a LED lamp with full light-emitting angle of the present invention with the LED board being in an unfolded state.

FIG. 4 is a top plan view of a lamp body of a LED lamp with full light-emitting angle of the present invention.

FIG. 5 is a perspective view of a LED board of a LED lamp with full light-emitting angle of the present invention with the LED board being in an unfolded state.

FIG. 6 is a perspective view of the LED board shown in FIG. 5 with the LED board being properly assembled.

### LIST OF REFERENCE NUMERALS OF MAIN COMPONENTS

1 lamp cap
2 base
21 bottom groove
22 screw hole
3 lamp body
31 drum-shaped base body
311 round tube
32 cylinder step
33 circular groove
34 polyhedron
341 wire groove
342 right prism
343 pyramidal frustum
344 top facet
35 transitional circular platform
351 screw hole
352 circular recess
36 screw
4 lamp cover
5 LED board
51 solder joint
52 solder joint
53 polygon facet
531 perforation
54 board body
541 vertical board
5411 vertical edge
542 oblique board
5421 horizontal edge
55 LED illuminant
6 support
61 hook
62 ring
63 frame
64 frame
65 frame
66 through-hole
7 stopper
71 circular plate
72 annular bearing body
721 semicircular notch
73 screw hole
74 step-like cylinder
75 wire groove
8 LED driver PCB
811 wire
812 wire
82 wire
41 fastener
331 fastening groove
9 heat radiation rubber

### DETAILED DESCRIPTION OF ILLUSTRATED EMBODIMENTS

Various preferred embodiments will now be described with reference to the figures:

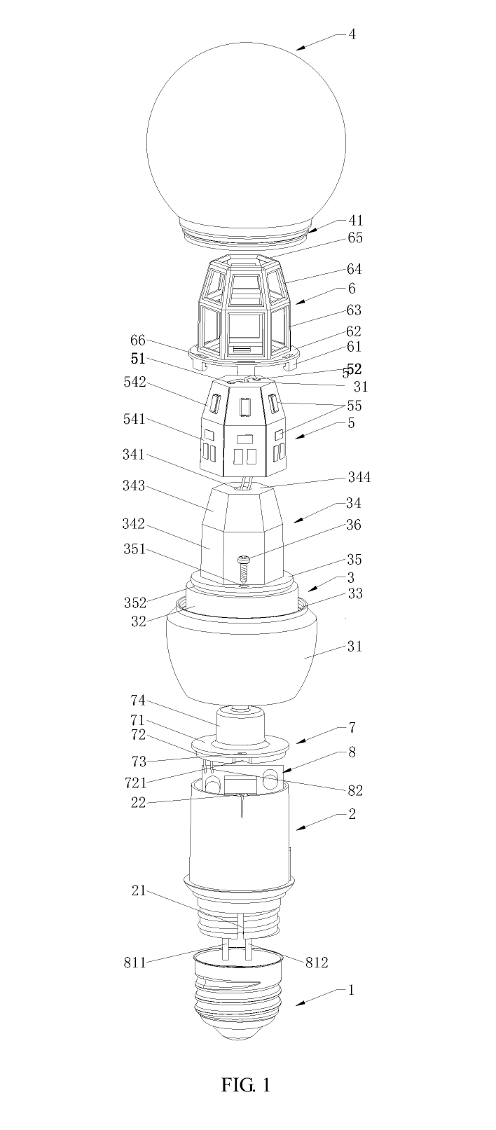

As shown in FIGS. 1, 2 and 4, a LED lamp with full light-emitting angle comprises a lamp cap 1, a base 2, a stopper 7, a lamp body 3 and a lamp cover 4 that are successively connected. The lamp body 3 is composed of a drum-shaped base body 31 at the bottom thereof, with longitudinal section of the drum-shaped base body being drum-shaped, a cylinder step 32 at the middle thereof, a circular groove 33 molded at a junction of the drum-shaped base body 31 and the cylinder step 32, a fastening groove 331 in the circular groove, a polyhedron 34 at the top thereof, a transitional circular platform 35 molded between the polyhedron 34 and the cylinder step 32, a screw hole 351 opened in the transitional circular platform 35, a circular recess 352 between the transitional circular platform 35 and the cylinder step 32, a round tube 311 having a consistent diameter throughout its length and molded in both the drum-shaped base body 31 and the cylinder step 32, and a wire groove 341 opened in the polyhedron 34 and communicating with the round tube 311. An external surface of the polyhedron 34 is covered over with a LED board 5 matching with a shape of the polyhedron. The LED board 5 is sleeved with a support 6 and is fixed on the lamp body 3 by fastening a hook 61 arranged at the bottom of the support into the circular recess 352 of the lamp body 3, and a stopper 7 is inserted into the wire groove 341 of the polyhedron from the bottom of the round tube 311 of the lamp body and is supported by the base 2, and a fastener 41 arranged at an end of the lamp cover 4 is fastened to the fastening groove 331 in the circular groove of the lamp body. A wire 811 at the bottom of a LED driver PCB 8 is inserted into a bottom groove 21 of the base 2 and a wire 812 is soldered to the lamp cap 1, while two wires 82 at the top of the LED driver PCB 8 both are inserted into a wire groove 75 in an inner cavity of the stopper 7 and are then fixed to a solder joint 51 and a solder joint 52 arranged at the LED board 5 after being drew out of the top of the lamp body 3.

As shown in FIG. 1 and FIG. 4, the polyhedron 34 is composed of a right prism 342 at lower part thereof, which is perpendicular to the transitional circular platform 35, a pyramidal frustum 343 at upper part thereof, which tilts inwards, and a top facet 344 of the pyramidal frustum 343.

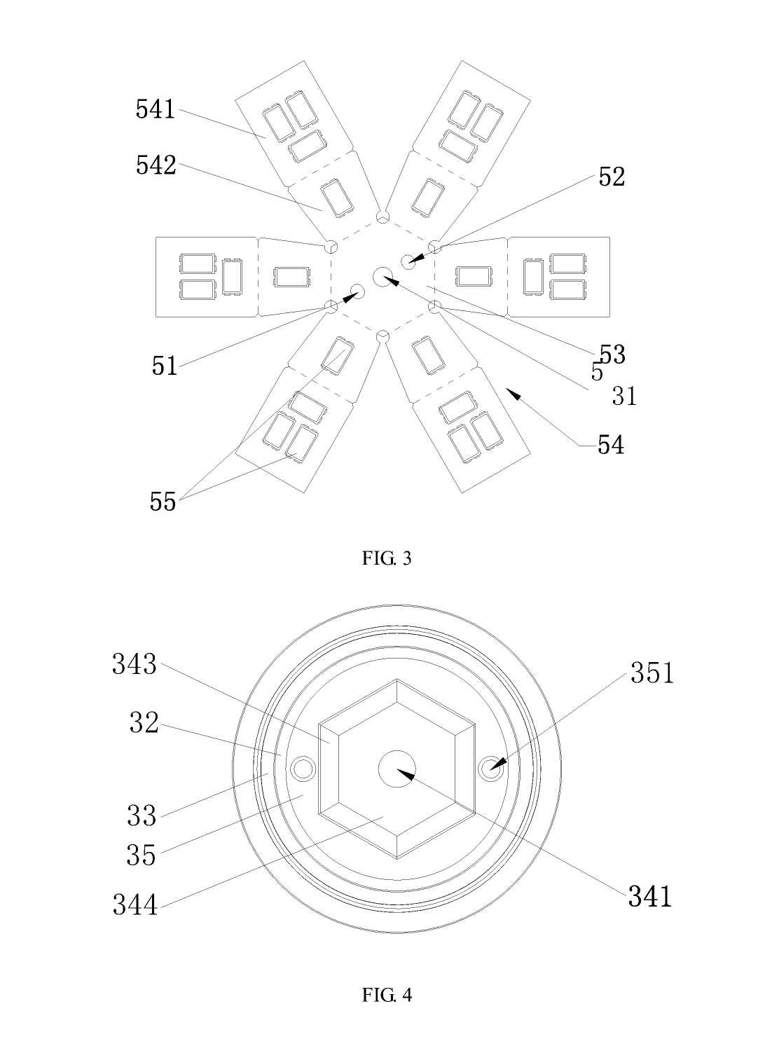

As shown in FIG. 3, the LED board 5 is composed of a polygon facet 53, a perforation 531 through the center of the polygon facet 53, a solder joint 51 and another solder joint 52 arranged around the perforation 531 for soldering wires, a plurality of board bodies 54 extending outwards from each side of the polygon facet 53, a LED illuminant 55 arranged on each board body 54, and a polyhedron body formed by connecting adjacent edges of the board bodies 54 and made up of a plurality of vertical boards 541 at lower part of the polyhedron body that are perpendicular to the cylinder step and a plurality of oblique boards 542 at upper part of the polyhedron body that are tilted relative to the cylinder step 32.

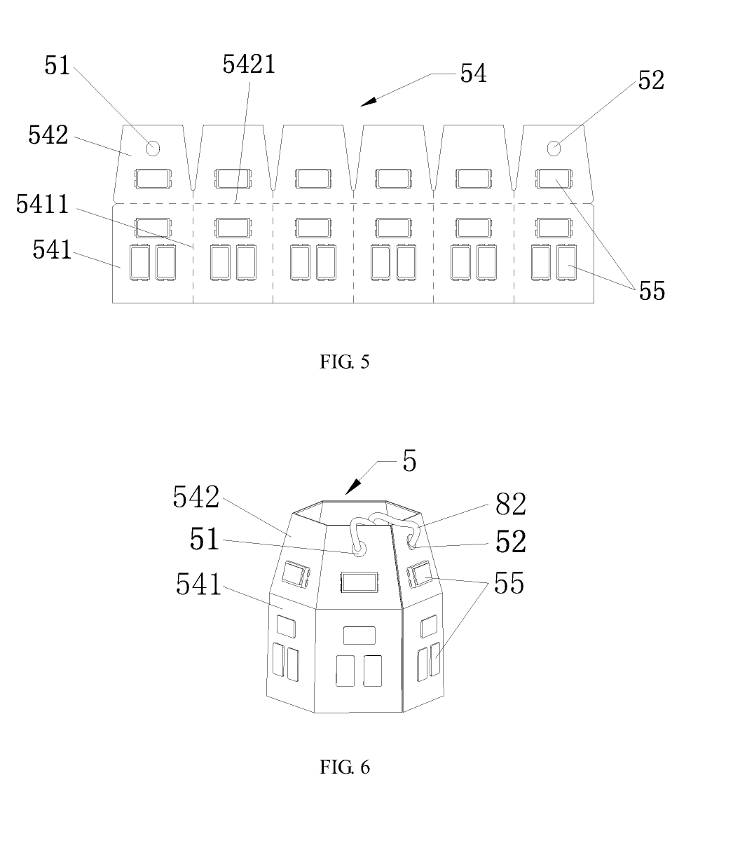

As shown in FIG. 5 and FIG. 6, another structure of a LED board 5 is composed of a circle of board bodies forming a lower prism and an upper pyramidal frustum, each board body consisting of a vertical board 541 at lower part thereof and an oblique board 542 at upper part thereof, two adjacent vertical boards 541 forming a vertical edge 5411, and each oblique board 542 tilting inwards along a horizontal edge 5421, a solder joint 51 and a solder joint 52 respectively arranged at two adjacent oblique boards 542, LED illuminants 55 arranged on the vertical board 541 and on the oblique board 542.

As shown in FIG. 1, the support 6 is composed of a ring 62 covering the transitional circular platform 35 of the lamp body, a plurality of hooks 61 protruding downwards from the bottom of the ring 62 to be fastened to the circular recess 352 of the lamp body, a frame 63 protruding upwards from the top of the ring 62 and arranged at lower part of the support, which matches with the vertical board 541 of the LED board, a frame 64 at upper part of the support, which matches with the oblique board 542 of the LED board, a frame 65 at the top of the support, which matches with the polygon facet of the LED board, and a plurality of through-holes 66 in the ring 62.

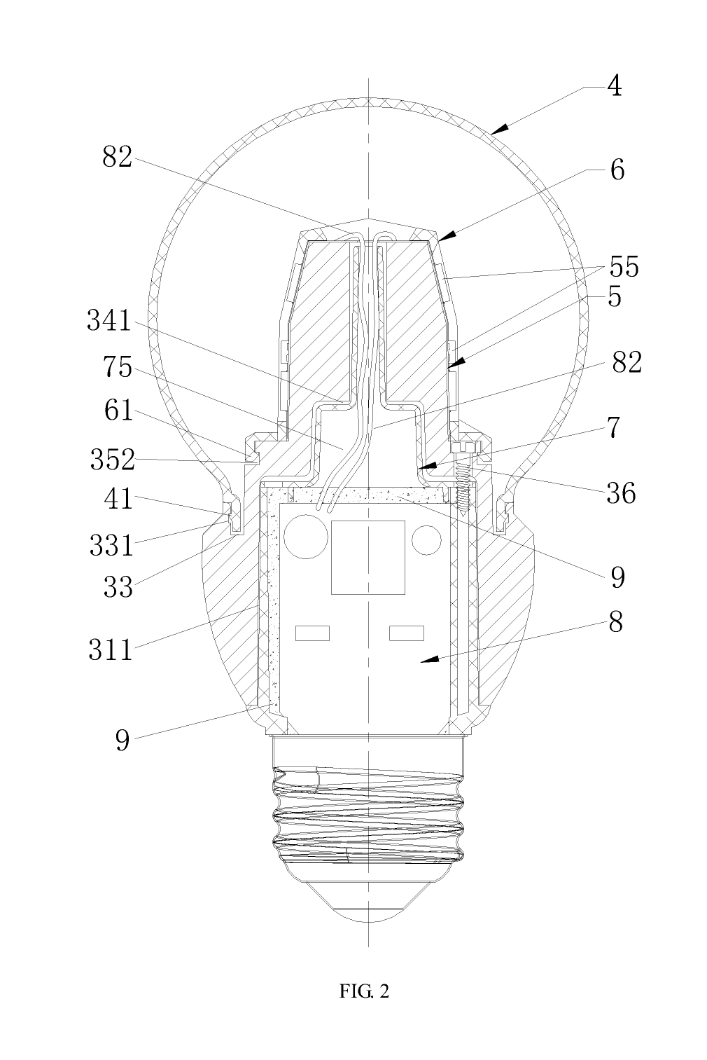

As shown in FIG. 1 and FIG. 2, the stopper 7 is composed of a circular plate 71, an annular bearing body 72 protruding downwards from the bottom of the circular plate 71 and inserted in an opening end of the base 2, a plurality of screw holes 73 opened in the circular plate 71, a semicircular notch 721 opened in the annular bearing body 72, which matches with the screw hole 73 of the circular plate, a step-like cylinder 74 protruding upwards from the top of the circular plate 71, diameter of the step-like cylinder decreasing with increasing height of the cylinder, and a wire groove 75 opened in an interior of the step-like cylinder 74, diameter of the wire groove decreasing with increasing height of the wire groove.

As shown in FIG. 2, a space between the base 2 and the LED driver PCB 8 is filled with a heat radiation rubber 9 to make heat of the LED driver PCB 8 dissipated out.

In the embodiment, a process of manufacturing of a LED lamp with full-emitting angle comprises the following steps:

(1) mounting a LED driver PCB 8 into a base 2, and inserting one wire 811 at the bottom of the LED driver PCB 8 into a bottom groove 21 of the base;
(2) connecting a lamp cap 1 to the base 2 by a threaded connection, then soldering another wire 812 at the bottom of the LED driver PCB 8 to the lamp cap 1, and filling a space between the base 2 and the LED driver PCB 8 with a heat radiation rubber 9 to make heat of the LED driver PCB 8 dissipated out;
(3) mounting a stopper 7 into both the base 2 and a lamp body 3, then inserting two wires 82 at the top of the LED driver PCB 8 into a wire groove 75 in an inner cavity of the stopper 7, and drawing the wires out of the top of the lamp body 3;
(4) screwing a screw 36 into a screw hole 351 of a transitional circular platform of the lamp body 3, a screw hole 73 of the stopper, and a screw hole 22 of the base to make the lamp body 3 and the stopper 7 connected with the base 2;
(5) covering a right prism 342, a pyramidal frustum 343 and a top facet 344 of a polyhedron of the lamp body with a LED board to make heat of a LED illuminant 55 dissipated out, and fixing the two wires 82 at the top of the LED driver PCB 8 respectively to two solder joints 51 and 52 arranged at two oblique boards 542 (as shown in FIG. 6) or arranged at a polygon facet 53 (as shown in FIG. 1 and FIG. 3);
(6) sleeving the LED board 5 with a support 6, and then fastening a hook 61 arranged at the bottom of the support 6 into a circular recess 352 between the transitional circular platform 35 and a cylinder step 32 of the lamp body;
(7) fastening a fastener 41 arranged at an end of a lamp cover 4 into a fastening groove 331 arranged in a circular groove of the lamp body to complete assembling of the LED lamp.

All the above are the preferred embodiments of the present invention, and the invention is intended to cover various modifications and equivalent arrangements included within the scope of the invention.

1. A LED lamp with full light-emitting angle, comprising
a lamp cap,
a base,
a stopper,
a lamp body, and
a lamp cover that are successively connected,
characterized in that: the lamp body is composed of
a drum-shaped base body at the bottom thereof, with longitudinal section of the drum-shaped base body being drum-shaped,
a cylinder step at the middle thereof,
a circular groove molded at a junction of the drum-shaped base body and the cylinder step,
a fastening groove in the circular groove,
a polyhedron at the top thereof,
a transitional circular platform molded between the polyhedron and the cylinder step,
a screw hole opened in the transitional circular platform,
a circular recess between the transitional circular platform and the cylinder step,
a round tube having a consistent diameter throughout its length and molded in both the drum-shaped base body and the cylinder step, and
a wire groove opened in the polyhedron and communicating with the round tube;
an external surface of the polyhedron is covered over with a LED board matching with a shape of the polyhedron;
the LED board is sleeved with a support and is fixed on the lamp body by fastening a hook arranged at the bottom of the support into the circular recess of the lamp body, a stopper is inserted into the wire groove of the polyhedron from the bottom of the round tube of the lamp body and is supported by the base, an end of the lamp cover is fastened to the fastening groove in the circular groove of the lamp body;
two wires at the bottom of a LED driver PCB are respectively inserted into a bottom groove of the base and soldered to the lamp cap, while two wires at the top of the LED driver PCB both are inserted into a wire groove in an inner cavity of the stopper and are then fixed to solder joints arranged at the LED board after being drew out of the top of the lamp body.

2. The LED lamp with full light-emitting angle according to claim 1, characterized in that: the polyhedron is composed of
a right prism at lower part thereof, which is perpendicular to the transitional circular platform,
a pyramidal frustum at upper part thereof, which tilts inwards, and
a top facet of the pyramidal frustum.

3. The LED lamp with full light-emitting angle according to claim 2, characterized in that: the LED board is composed of
a polygon facet,
a perforation through the center of the polygon facet,
a solder joint arranged around the perforation for soldering a wire,
a plurality of board bodies extending outwards from each side of the polygon facet,
a LED illuminant arranged on each board body, and
a polyhedron body formed by connecting adjacent edges of the board bodies and made up of a plurality of vertical boards at lower part of the polyhedron body that are perpendicular to the cylinder step and a plurality of oblique boards at upper part of the polyhedron body that are tilted relative to the cylinder step.

4. The LED lamp with full light-emitting angle according to claim 3, characterized in that: the support is composed of
a ring covering the transitional circular platform of the lamp body,
a plurality of hooks protruding downwards from the bottom of the ring to be fastened to the circular recess of the lamp body,
a frame protruding upwards from the top of the ring and arranged at lower part of the support, which matches with the vertical board of the LED board,
a frame at upper part of the support, which matches with the oblique board of the LED board,
a frame at the top of the support, which matches with the polygon facet of the LED board, and
a plurality of through-holes in the ring.

5. The LED lamp with full light-emitting angle according to claim 1, characterized in that: the stopper is composed of
a circular plate,
an annular bearing body protruding downwards from the bottom of the circular plate and inserted in an opening end of the base,
a plurality of screw holes opened in the circular plate,
a semicircular notch opened in the annular bearing body, which matches with the screw hole of the circular plate,
a step-like cylinder protruding upwards from the top of the circular plate, diameter of the step-like cylinder decreasing with increasing height of the cylinder, and
a wire groove opened in an interior of the step-like cylinder, diameter of the wire groove decreasing with increasing height of the wire groove.

6. The LED lamp with full light-emitting angle according to claim 1, characterized in that: a space between the base and the LED driver PCB is filled with a heat radiation rubber to make heat of the LED driver PCB dissipated out.

7. The LED lamp with full light-emitting angle according to claim 1, characterized in that: the LED board is composed of
a circle of board bodies forming a lower prism and an upper pyramidal frustum, each board body consisting of a vertical board at lower part thereof and an oblique board at upper part thereof, two adjacent vertical boards forming a vertical edge, and each oblique board tilting inwards along a horizontal edge,
two solder joints respectively arranged at two adjacent oblique boards,
LED illuminants arranged on the vertical board and on the oblique board.

8. A process of manufacturing of a LED lamp with full light-emitting angle according to claim 1, characterized by comprising the steps of:
(1) mounting a LED driver PCB into a base, and inserting one wire at the bottom of the LED driver PCB into a bottom groove of the base;
(2) connecting a lamp cap to the base by a threaded connection, then soldering another wire at the bottom of the LED driver PCB to the lamp cap, and filling a space between the base and the LED driver PCB with a heat radiation rubber to make heat of the LED driver PCB dissipated out;
(3) mounting a stopper into both the base and a lamp body, then inserting two wires at the top of the LED driver PCB into a wire groove in an inner cavity of the stopper, and drawing the wires out of the top of the lamp body;
(4) screwing a screw into a screw hole of a transitional circular platform of the lamp body, a screw hole of the stopper, and a screw hole of the base to make the lamp body and the stopper connected with the base;
(5) covering each facet of a polyhedron of the lamp body with a LED board to make heat of a LED illuminant dissipated out, and fixing the two wires at the top of the LED driver PCB to solder joints arranged at the LED board;
(6) sleeving the LED board with a support, and then fastening a hook arranged at the bottom of the support into a circular recess between the transitional circular platform and a cylinder step of the lamp body;
(7) fastening a fastener arranged at an end of a lamp cover into a fastening groove arranged in a circular groove of the lamp body to complete assembling of the LED lamp.
